(19) United States
(12) Patent Application Publication
(10) Pub. No.: US 2014/0136785 A1
(43) Pub. Date: May 15, 2014

(54) ENHANCED CACHE COORDINATION IN A MULTILEVEL CACHE

(71) Applicant: INTERNATIONAL BUSINESS MACHINES CORPORATION, Armonk, NY (US)

(72) Inventor: Daniel J. Colglazier, Cary, NC (US)

(73) Assignee: International Business Machines Corporation, Armonk, NY (US)

(21) Appl. No.: 13/692,035

(22) Filed: Dec. 3, 2012

Related U.S. Application Data
(63) Continuation of application No. 13/672,896, filed on Nov. 9, 2012.

(51) Int. Cl. G06F 12/08

(52) U.S. Cl. CPC G06F 12/0811
USPC 711/122

(57) ABSTRACT

Embodiments of the present invention provide a method, system and computer program product for enhanced cache coordination in a multi-level cache. In an embodiment of the invention, a method for enhanced cache coordination in a multi-level cache is provided. The method includes receiving a processor memory request to access data in a multi-level cache and servicing the processor memory request with data in either an L1 cache or an L2 cache of the multi-level cache. The method additionally includes marking a cache line in the L1 cache and also a corresponding cache line in the L2 cache as most recently used responsive to determining that the processor memory request is serviced from the cache line in the L1 cache and that the cache line in the L1 cache is not currently marked most recently used.

### BACKGROUND OF THE INVENTION

1. Field of the Invention

The present invention relates to multi-level caching and more particularly to cache coordination in a multi-level cache.

2. Description of the Related Art

Memory cache technologies have formed an integral part of computer engineering and computer science for well over two decades. Initially embodied as part of the underlying hardware architecture of a data processing system, data caches and program instruction caches store often-accessed data and program instructions in fast memory for subsequent retrieval in lieu of retrieving the same data and instructions from slower memory stores. Consequently, substantial performance advantages have been obtained through the routine incorporation of cache technologies in computer designs.

Most modern processors provide three independent caches: an instruction cache to accelerate executable instruction fetches, a data cache to accelerate data fetch and store operations, and a translation lookaside buffer to accelerate virtual-to-physical address translation for both executable instructions and data. With respect just to the data cache, typically the data cache is organized into a hierarchy of more cache levels, generally referred to as L1, L2, etc. The hierarchical organization is provided primarily to balance the need for high hit rates and correspondingly low miss rates with the latency inherent to memory operations. Consequently, multi-level caches generally operate by checking the smallest L1 cache first in response to which with a hit the processor proceeds at high speed, but otherwise in response to smaller cache misses, a next larger L2 cache is checked, and so forth, before external memory is checked.

In a caching architecture, whether single level or multi-level, fetched data from main memory is transferred between main memory and a level of the cache in blocks of fixed size, referred to as cache lines. When a cache line is copied from memory into the cache, a cache entry is created. Thereafter, most caches use some sort of reference pattern information to decide which line in a cache to replace when a new line is brought into the cache. An example is the least recently used replacement policy in which a line that has not been referenced for the longest period of time is the line selected for eviction—namely replacement.

The least recently used policy of cache eviction works well generally because the more recently referenced cache lines are more likely to be referenced again. Further, the least recently used policy of cache eviction works well at the first level, L1 cache in a multi-level cache because L1 “sees” all processor memory references as a matter of course. In contrast, other levels deeper in the hierarchy of a multi-level cache, including L2, “see” only processor memory references that miss L1 or writebacks from L1. Thus, the processor memory reference pattern at L2 can be quite different than that of L1 which can result in cache lines being replaced in L2 though those same lines may be quite active in L1 as cache hits. As such, a lack of tight coordination between L1 and L2 in a multi-level cache can result in undesirable cache inefficiencies.

### BRIEF SUMMARY OF THE INVENTION

Embodiments of the present invention address deficiencies of the art in respect to multi-level caching and provide a novel and non-obvious method, system and computer program product for enhanced cache coordination in a multi-level cache. In an embodiment of the invention, a method for enhanced cache coordination in a multi-level cache is provided. The method includes receiving a processor memory request to access data in a multi-level cache and servicing the processor memory request with data in either an L1 cache or an L2 cache of the multi-level cache. The method additionally includes marking a cache line in the L1 cache used to service the request with the data, and also a cache line in the L2 cache also referencing the same data, hereinafter referred to as the corresponding cache line in L2, as most recently used responsive to determining that the processor memory request is serviced from the cache line in the L1 cache and that the cache line in the L1 cache is not currently marked most recently used.

In one aspect of the embodiment, the method additionally includes determining that the request has been serviced with a cache line from the L2 cache, replacing an existing cache line in the L1 cache with the cache line from the L2 cache, sending the address of the replaced cache line in the L1 cache to the L2 cache and marking the corresponding cache line in the L2 cache as least recently used responsive to determining that the processor memory request is serviced from a cache line in the L2 cache rather than the L1 cache and that the replaced cache line in the L1 cache does not exist in any other L1 cache of the multi-level cache. In yet another aspect of the embodiment, the method yet additionally includes determining that the request has been serviced with a cache line from the L2 cache, replacing an existing cache line in the L1 cache with the cache line from the L2 cache, and writing back the replaced cache line in the L1 cache to the L2 cache responsive to determining that the processor memory request is serviced from a cache line in the L2 cache rather than the L1 cache and that the replaced cache line in the L1 cache is both valid and has been modified prior to the replacement of the existing cache line with the cache line from the L2 cache.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for enhanced cache coordination in a multi-level cache;

FIG. 2 is a schematic illustration of a data processing system configured for enhanced cache coordination in a multi-level cache; and,

FIG. 3 is a flow chart illustrating a process for enhanced cache coordination in a multi-level cache.

### DETAILED DESCRIPTION OF THE INVENTION

Embodiments of the invention provide for enhanced cache coordination in a multi-level cache. In accordance with an embodiment of the invention, a multi-level cache can be coupled to main memory and provided to include at least a first level cache (L1) and a second level cache (L2). Memory requests to main memory can be processed in the multi-level cache with cache hits resulting in a cache line returned from L1 rather than main memory. Cache misses on L1 can result in the requests processed against L2 before main memory. Cache hits on L1 of a cache line not already marked as most recently used in L1 can result in the cache line becoming marked in L1 as most recently used. Additionally, L2 can be notified of cache hits on L1 of a cache line not already marked as most recently used in L1 so as to mark the corresponding cache line in L2 also as most recently used. In this way, it becomes less probable that L2 will invalidate the cache line before the same cache line is invalidated in L1.

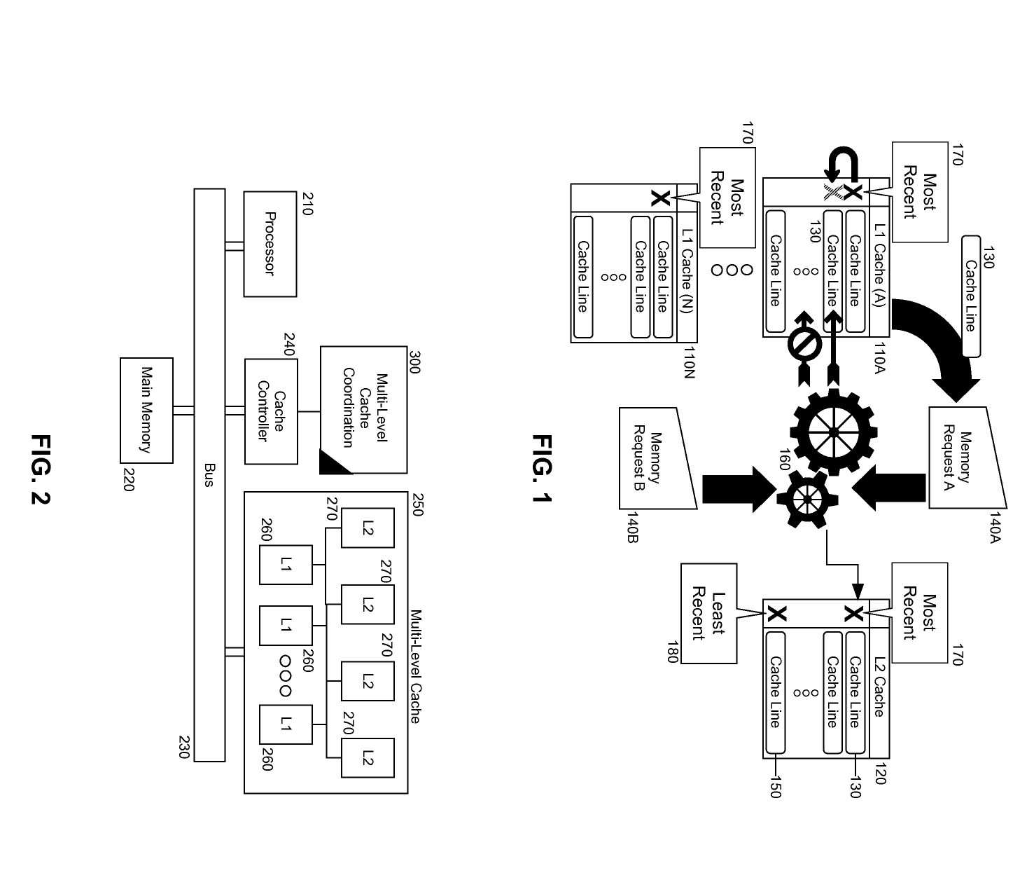

In further illustration, FIG. 1 pictorially shows a process for enhanced cache coordination in a multi-level cache. As shown in FIG. 1, cache coordination logic 160 can manage reference pattern information 170, 180 for different L1 caches 110A, 110N and at least one L2 cache 120 in a multi-level cache infrastructure. The cache coordination logic 160 can provide dual enhancements to assist in improving replacements in the L2 cache 120 and to improve hit rates in the L1 caches 110A, 110N and the L2 cache 120. Specifically, in a first enhancement, in response to a memory request 140A seeking a cache line 130 in one L1 cache 110A, to the extent that the cache line 130 is not currently marked in its reference pattern information 170 as most recent, the cache coordination logic 160 can mark cache line 130 in its reference pattern information 170 as most recently accessed. Additionally, the cache coordination logic 160 can mark a corresponding cache line 130 in the L2 cache 120 as most recently used in its reference pattern information 170.

In the second enhancement, a memory request 140B can be received that can be serviced with data from the L2 cache 120 and not any of the L1 caches 110A, 110N. In response, the cache coordination logic can replace a cache line in the L1 caches 110A, 110N with an unmodified cache line and the cache coordination logic 160 can mark the corresponding cache line 150 in the L2 cache 120 in its reference pattern information 180 as least recently accessed. In this way, the L2 cache 120 will enjoy an awareness that the cache line 150 is a good candidate for replacement. Of note, both cache coordination enhancements described herein assist in improving replacements in the L2 cache 120 and also in improving the hit rates in the L1 caches 110A, 110N and the L2 cache 120.

The process described in connection with FIG. 1 can be implemented in a memory cache management data processing system. In yet further illustration, FIG. 2 is a schematic illustration of a data processing system configured for enhanced cache coordination in a multi-level cache. The system can include a processor 210 coupled to main memory 220 over a communications bus 230. A multi-level cache 250 for the main memory 220 can be accessed by the processor 210 over the bus 230 by way of a cache controller 240. In this regard, the multi-level cache 250 can include one or more L1 caches 260 and one or more L2 caches 270. Of note, a multi-level cache coordination module 300 can be coupled to the cache controller 240 and configured for enhanced cache coordination.

More particularly, the multi-level cache coordination module 300 can include program code that when executed first can respond to a cache line retrieval from one of the L1 caches 260 that is not marked most recently accessed by marking the cache line in the one of the L1 caches 260 as most recently accessed, and also marking a corresponding cache line in one of the L2 caches 260 as most recently accessed. The multi-level cache coordination module 300 also can include program code that when executed second can respond to a cache line miss in the L1 caches 260 and a cache retrieval responsive to the request from one of the L2 caches 270 with a replacement of a cache line in one of the L1 caches 260 of an unmodified cache line and a marking of a corresponding cache line in one of the L2 caches 270 as least recently used. In this way, the program code of the multi-level cache coordination module 300 can assist in improving replacements in the L2 caches 270 and also in improving the hit rates in the L1 caches 260 and the L2 caches 270.

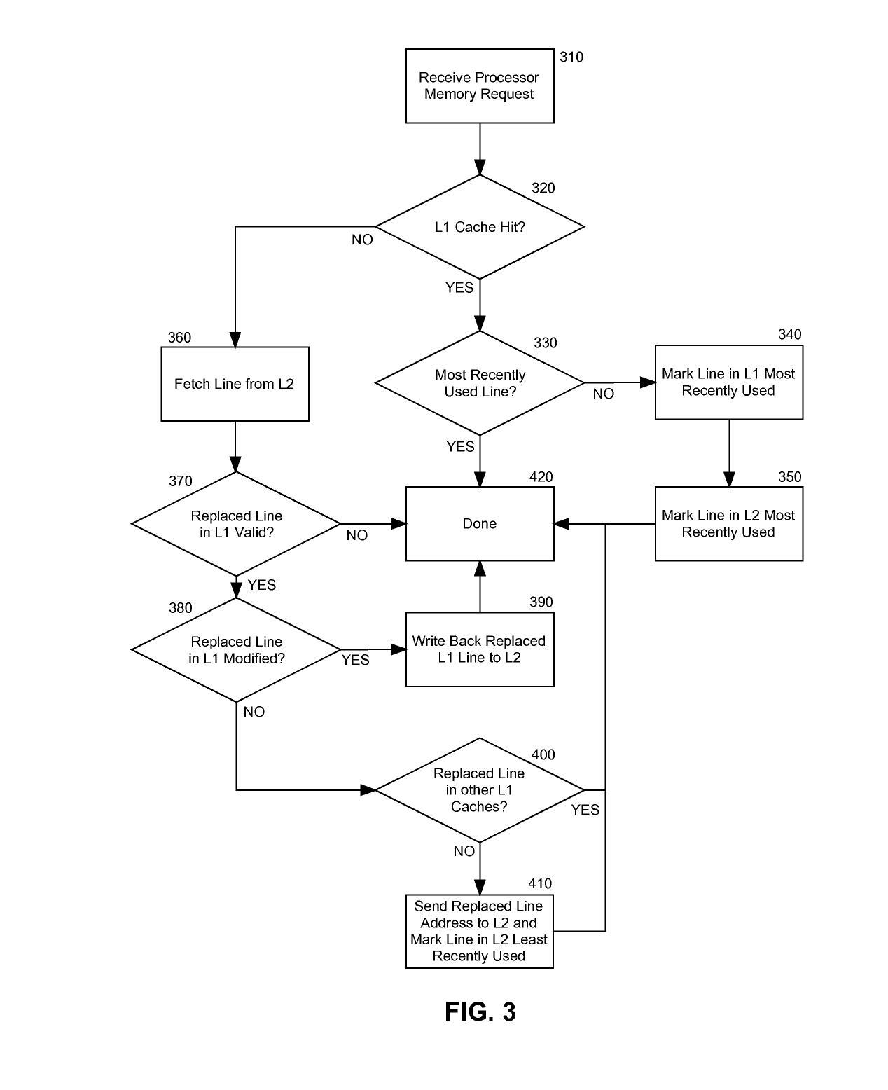

In yet further illustration of the operation of the multi-level cache coordination module 300, FIG. 3 is a flow chart illustrating a process for enhanced cache coordination in a multi-level cache. Beginning in block 310, a processor memory request can be received. In decision block 320, it can be determined if the request results in an L1 cache hit. If so, it further can be determined in decision block 330 whether or not the L1 cache hit is for a most recently used cache line in the L1 cache. If not, in block 340 the cache line from which the request is serviced in the L1 cache can be marked as most recently used. Additionally, in block 350, a corresponding cache line in the L2 cache can be marked as most recently used. Thereafter, the process can end in block 420.

In decision block 320, if it is determined that the request does not result in an L1 cache hit, in block 360 the request can be serviced from a cache line in L2 and an existing cache line in the L1 cache can be replaced with the cache line corresponding to that of the L2 cache from which the request is serviced. Subsequently, in decision block 370 it can be determined if the replaced cache line in the L1 cache is a valid cache line. If so, in decision block 380 it further can be determined whether or not the replaced cache line in the L1 cache had been modified. If so, in block 390 the replaced cache line can be written back to the L2 cache. Otherwise, in decision block 400 it yet further can be determined whether or not the replaced cache line in the L1 cache already exists in other L1 caches of the multi-level cache. If not, the address of the replaced line can be sent to the L2 cache and a corresponding cache line in the L2 cache can be marked as least recently used in block 410. Thereafter, the process can end in block 420.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware- based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A method for enhanced cache coordination in a multi-level cache, the method comprising:
receiving a processor memory request to access data in a multi-level cache;
servicing the processor memory request with data in either an L1 cache or an L2 cache of the multi-level cache; and,
marking a cache line in the L1 cache and also a corresponding cache line in the L2 cache as most recently used responsive to determining that the processor memory request is serviced from the cache line in the L1 cache and that the cache line in the L1 cache is not currently marked most recently used.

2. The method of claim 1, further comprising determining that the request has been serviced with a cache line from the L2 cache, replacing an existing cache line in the L1 cache with the cache line from the L2 cache, sending an address of the replaced cache line to the L2 cache and marking a corresponding cache line in the L2 cache as least recently used responsive to determining that the processor memory request is serviced from a cache line in the L2 cache rather than the L1 cache and that the replaced cache line in the L1 cache does not exist in any other L1 cache of the multi-level cache.

3. The method of claim 1, further comprising determining that the request has been serviced with a cache line from the L2 cache, replacing an existing cache line in the L1 cache with the cache line from the L2 cache, and writing back the replaced cache line to the L2 cache responsive to determining that the processor memory request is serviced from a cache line in the L2 cache rather than the L1 cache and that the replaced cache line is both valid and has been modified prior to the replacement of the existing cache line with the cache line from the L2 cache.

4. A method for enhanced cache coordination in a multi-level cache, the method comprising:
receiving a processor memory request to access data in a multi-level cache;
servicing the processor memory request with data in a cache line of an L2 cache of the multi-level cache;
replacing an existing cache line in an L1 cache of the multi-level cache with the cache line from the L2 cache; and, sending an address of the replaced cache line to the L2 cache and marking a corresponding cache line in the L2 cache as least recently used responsive to determining that the replaced cache line in the L1 cache does not exist in any other L1 cache of the multi-level cache.

5. The method of claim 4, further comprising servicing a subsequent request with a different cache line from the L2 cache, replacing a different cache line in the L1 cache with the different cache line from the L2 cache, and writing back the replaced cache line in the L1 cache to the L2 cache responsive to determining that the replaced cache line in the L1 cache is both valid and has been modified prior to the replacement of the different cache line in the L1 cache with the different cache line from the L2 cache.

6-15. (canceled)
